(19) United States
(12) Patent Application Publication
(10) Pub. No.: US 2011/0003511 A1
(43) Pub. Date: Jan. 6, 2011

(54) CONNECTOR INCLUDING ELECTRONIC DEVICE

(75) Inventor: Jonathan Betts-LaCroix, Chatsworth, CA (US)

Correspondence Address: MATTINGLY & MALUR, P.C., 1800 DIAGONAL ROAD, SUITE 370, ALEXANDRIA, VA, 22314, US

(73) Assignee: OQO, INC., San Francisco, CA (US)

(21) Appl. No.: 12/409,890

(22) Filed: Mar. 24, 2009

(51) Int. Cl. H01R 13/66; H04L 9/00

(52) U.S. Cl. 439/620.21; 380/277

(57) ABSTRACT

A electronic device is disclosed in which substantially all of the electronic components of the device reside within a connector suitable for coupling to a port on a computing device. The device, referred to as a “dongle,” may therefore have an overall volume that is less than that of other devices for performing the same function. The dongle may, for example, perform the function of an encryption key to protect the computing device against unauthorized use. The dongle may be mated with the computing device port, thereby enveloping substantially all of the dongle within the port. The dongle does not extend appreciably from the port to which it is mated, thereby not adding appreciably to the volume of the computing device, and thereby making it easier to transport the computing device while the dongle is coupled to it.

### BACKGROUND

1. Field Of The Invention

The present invention relates to connectors for use with computing devices and, in particular, to portable electronic devices having a connector that may be connected to a port of a computing device.

2. Related Art

Improvements in miniaturization technology continue to make it possible to design and manufacture increasingly small and portable computing devices. Handheld computers weighing a few ounces provide computing power comparable to that provided by desktop computers available just a few years ago.

Users of portable computing devices are demanding that such devices provide connectivity features comparable to conventional desktop computers, including the ability to connect such devices to the Internet and to peripheral devices such as printers, monitors, speakers, microphones, scanners, and digital cameras. Although in some cases it may be possible to make such connections wirelessly, in many cases such connections must be established using physical cables. To ensure that a portable computing device is capable of establishing a cable connection, it is necessary to provide the portable computing device with ports capable of mating with various kinds of cable connectors.

Although the size of a cable connector is negligible compared to the size of a conventional desktop computer, the size of ports and connectors is beginning to dominate the size of portable computing devices as such devices continue to decrease in size. The size of a Universal Serial Bus (USB) connector, for example, may be a significant fraction of the size of an entire portable computing device itself.

Consider, for example, the category of devices referred to as a “dongle.” A dongle is a small device, typically less than a few inches long and less than an inch wide and thick, that has a connector on one end that may be connected to a conventional computer port, such as a serial port, parallel port, or USB port. A dongle may, for example, be used to ensure that a particular computer or software application is not used by unauthorized users or in unauthorized ways. Each copy of a particular software application may, for example, be distributed with a corresponding dongle that includes an electronic memory in which is stored a (typically encrypted) unique key associated with the copy of the software. To use the software; the user must connect the dongle to a port on the computer. When the user attempts to execute the software, the software determines whether a dongle having the correct key is connected to the computer and only executes if such a dongle is so connected. The dongle therefore provides a relatively effective means for enforcing software copy protection.

Some dongles are used instead as persistent storage devices. Such dongles include a persistent storage medium and, when connected to a port on a computer, may be used to read and write data in a manner similar to a hard disk drive or floppy disk drive. The small size of such a dongle enables it to be easily transported and connected to other computers, thereby enabling it to perform functions similar to that of a conventional floppy diskette, without requiring that computers to which it is connected be equipped with a corresponding disk drive.

Examples of commercially-available dongles include the Key-Lok II line of dongles available from Microcomputer Applications, Inc. of Denver, Colo.; the CRYPTO-BOX line of dongles available from Marx International, Inc., of Atlanta, Ga.; and the Dinkey Dongles line of dongles, available from Microcosm Limited of Bristol, UK. Although such dongles are relatively small, they still extend outward from the ports to which they are coupled, thereby increasing the effective size of the computing device.

This result may be undesirable for any of several reasons. For example, the appearance of the relatively large dongle extending from a relatively small computing device may be aesthetically unpleasing. Furthermore, the extending dongle may be susceptible to breakage when the portable computing device is transported. In addition, it may not be possible to store the computer device in a form-fitting carrying case when the dongle is connected to it, making it necessary to remove the dongle prior to transporting the computing device. It may be inconvenient and time-consuming to disconnect and reconnect the dongle each time the portable computing device is transported, and the dongle may be more likely to be lost if it needs to be disconnected and stored separately each time the portable computing device is. transported.

What is needed, therefore, are techniques for reducing the size of connectors for use with computing devices.

### SUMMARY

A electronic device is disclosed in which substantially all of the electronic components of the device reside within a connector suitable for coupling to a port on a computing device. The device, referred to as a “dongle,” may therefore have an overall volume that is less than that of other devices for performing the same function. The dongle may, for example, perform the function of an encryption key to protect the computing device against unauthorized use. The dongle may be mated with the computing device port, thereby enveloping substantially all of the dongle within the port. In this case, the dongle would not extend appreciably from the port to which it is mated, thereby not adding appreciably to the volume of the computing device, and thereby making it easier to transport the computing device while the dongle is coupled to it. The dongle may include means, such as a thin tongue or tab, which may extend from the port and be grasped to de-couple the dongle from the port. Alternatively, a separate removal device may be engaged with interior features of the dongle to de-couple and remove the dongle from the port.

Other features and advantages of various aspects and embodiments of the present invention will become apparent from the following description and from the claims.

### BRIEF DESCRIPTION OF THE DRAWINGS

FIG. 1 is a front perspective view of an electronic device according to a first embodiment of the present invention;

FIG. 2 is a front view of the electronic device of FIG. 1;

FIG. 3 is a rear perspective view of the electronic device of FIG. 1;

FIG. 4 is a front perspective view of a conventional Universal Serial Bus (USB) port;

FIG. 5 is a front perspective view of the electronic device of FIG. 1 coupled with the USB port of FIG. 4;

FIG. 6 is a front perspective view of an electronic device according to a second embodiment of the present invention;

FIG. 7 is a front perspective view of the electronic device of FIG. 6 coupled with the USB port of FIG. 4;

FIG. 8 is a schematic block diagram of the electronics of the device of FIG. 1 according to one embodiment of the present invention;

FIG. 9 is a flowchart of a method that may be performed by a processor of the electronic device of FIG. 1 to perform encryption key verification according to one embodiment of the present invention; and

FIG. 10 is a dataflow diagram illustrating the operations performed by and the data flow between a USB processor and a host computer according to the method illustrated in FIG. 9.

### DETAILED DESCRIPTION

A electronic device is disclosed in which substantially all of the electronic components of the device reside within a connector suitable for coupling to a port on a computing device. The device, referred to as a “dongle,” may therefore have an overall volume that is less than that of other devices for performing the same function. The dongle may, for example, perform the function of an encryption key to protect the computing device against unauthorized use. The, dongle may be mated with the computing device port, thereby enveloping substantially all of the dongle within the port. The dongle does not extend appreciably from the port to which it is mated, thereby not adding appreciably to the volume of the computing device, and thereby making it easier to transport the computing device while the dongle is coupled to it. The dongle may include means, such as a thin tongue or tab, which may extend from the port and be grasped to de-couple the dongle from the port. Alternatively, a separate removal device may be engaged with interior features of the dongle to de-couple and remove the dongle from the port.

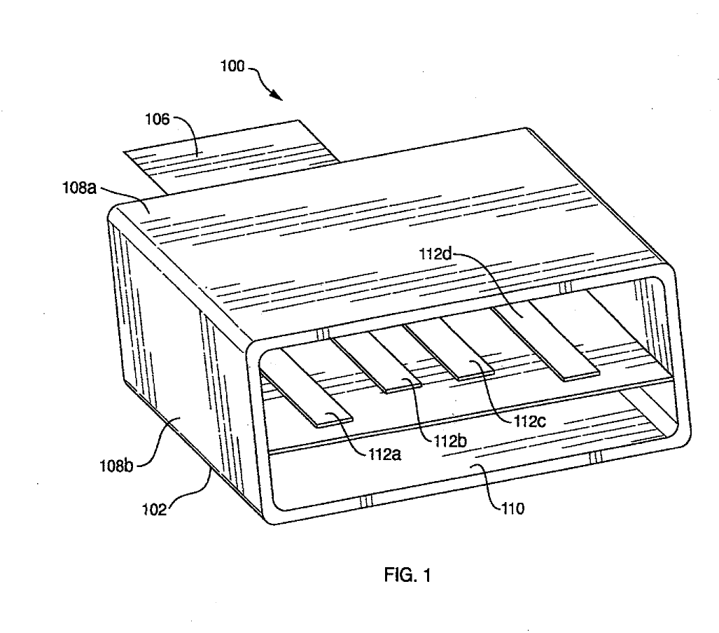

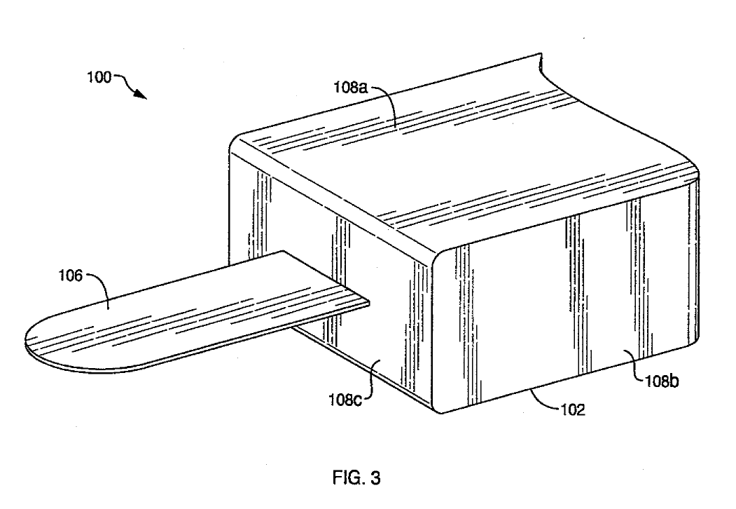

Referring to FIG. 1, a front perspective view is shown of an electronic device 100, also referred to as a “dongle,” according to a first embodiment of the present invention. The dongle 100 includes an exterior housing 102, electronics 104 within the housing 102, and a tab 106 (also referred to as a “pigtail”), which may or may not be flexible or hinged, extending from rear surface 108c (FIG. 3) of the housing 102. The pigtail 106 may serve as an attachment device to facilitate a user in retaining the dongle 100 securely when it is not inserted into the port 400; for instance, the pigtail 106 could be flexible or hinged, and serve as a loop for connecting to a keychain. In the embodiment of the dongle 100 illustrated in FIG. 1, the electronics 104 are entirely contained within the housing 102. Referring to FIG. 3, a rear perspective view of dongle 100 is shown.

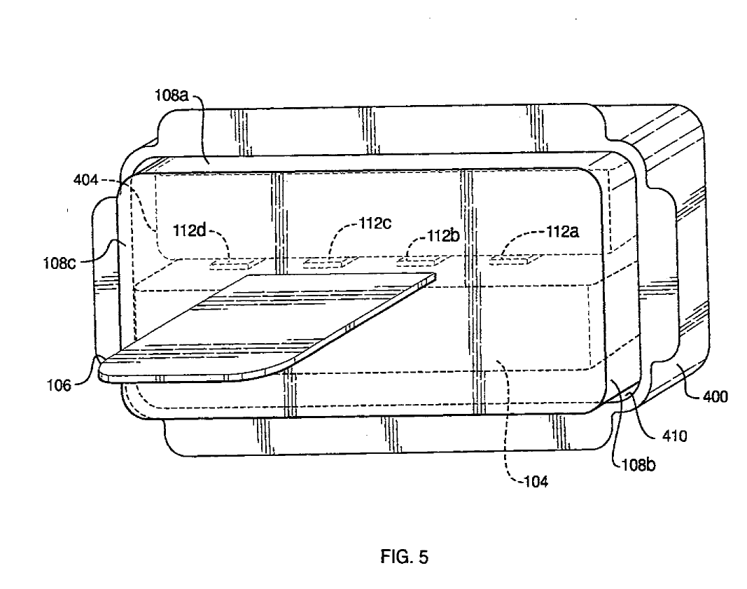

In the embodiment of the dongle 100 illustrated in FIG. 1, the combination of housing 102 and electronics 104 form a connector in compliance with the Universal Serial Bus (USB) Specification, Revision v2.0, dated Apr. 27, 2000, hereby incorporated by reference. In particular, the housing 102 implements a connector housing in conformance with the USB specification and the electronics 104 implement a connector tongue in conformance with the USB specification. As a result, when the dongle 100 is coupled to a corresponding USB port, all or substantially all of the housing 102 and electronics 104 are enveloped by the USB port, as described in more detail below with respect to FIG. 5.

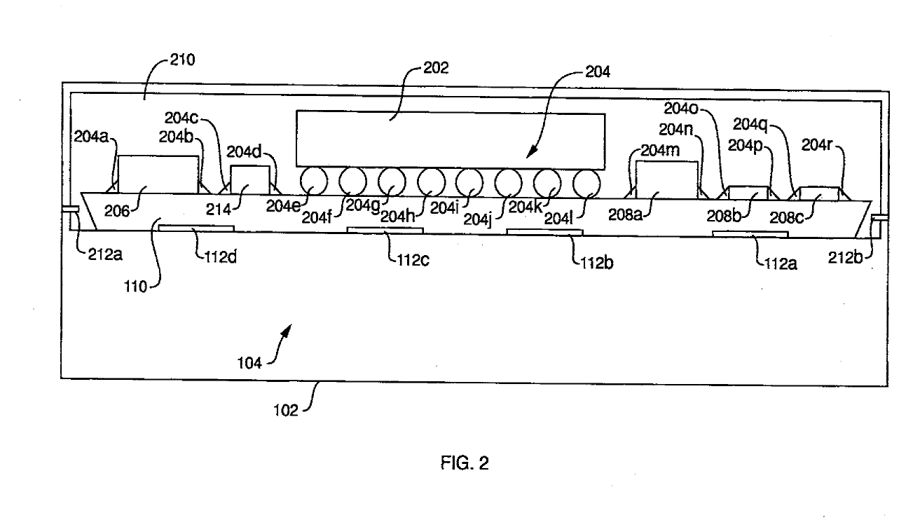

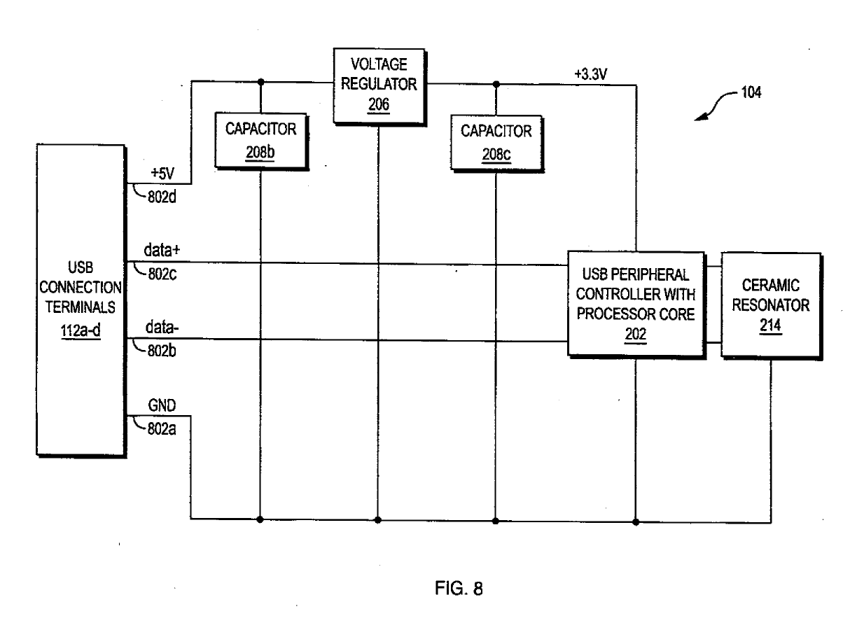

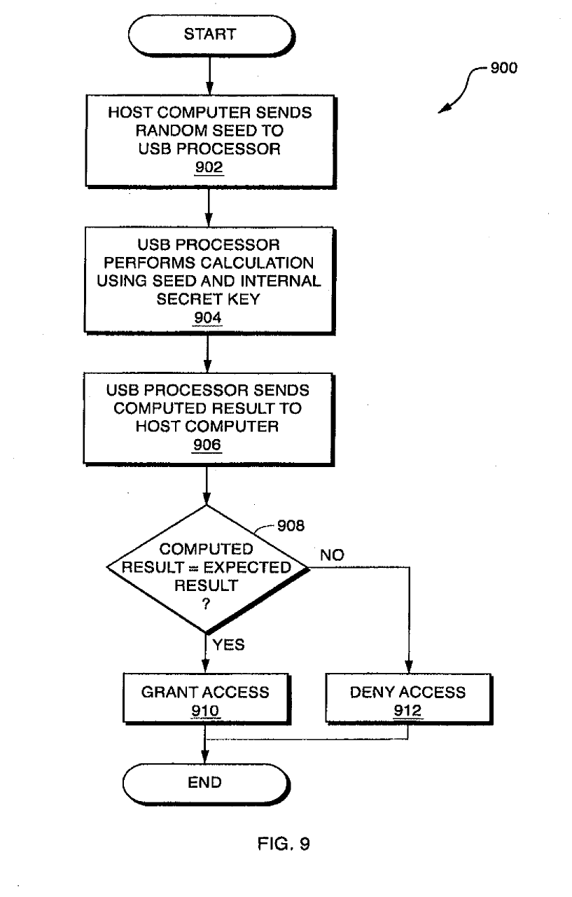

Electronics 104 include a printed circuit (PC) board 110 and gold-plated connector terminals 112a-d printed on the PC board 110. Referring to FIG. 2, a front view of the dongle 100 is shown which reveals additional components of the electronics 104 not shown in FIG. 1. As described in more detail below with respect to FIGS. 8-9, the electronics 104 shown in FIG. 2 may be used, for example, to perform the function of an encryption key.

The electronics 104 include: a USB peripheral controller with processor core 202-(referred to hereinafter as the “USB processor”); a voltage regulator integrated circuit (IC) 206; miscellaneous passive components, such as a resistor 208a and capacitors 208b-c; and a ceramic resonator 214. All of the components 202, 204, 206, 208a-c, 214 are soldered to the PC board 110 by solder connections 204a-r and are encapsulated within molded encapsulant 210. Housing 102 additionally includes locking tabs 212a-b to lock the housing 102 with a corresponding USB port (FIG. 5).

Examples of components that may be used to implement the electronics 104 include the following. The controller 202 may be implemented using the CY7C68013-56LFC EZ-USB® FX™ USB Microcontroller High-Speed USB Peripheral Controller from Cypress Semiconductor Corporation of San Jose, Calif. The CY7C68013-56LFC has dimensions of 8 mm×8 mm×1 mm. The voltage regulator 206 may be implemented using the MAX1819EBL33 voltage regulator, available from Maxim Integrated Products, Inc. of Sunnyvale, Calif. The MAX1819EBL33 has dimensions of 1.52 mm×1.52 mm×0.60 mm. The ceramic resonator 214 may be implemented using the 24 MHz CSTCG_V-24.0 ceramic resonator, available from Murata Manufacturing Co., Ltd., of Kyoto, Japan. The CSTCG_V-24.0 has dimensions of 2.00 m×1.30 mm×0.85 mm. The capacitors 208b-c may be implemented using the 0.1 μF GRP155R61A104KA01K capacitor, available from Murata Manufacturing Co. The GRP155R61A104KA01K capacitor has dimensions of 1.00 m×0.50 mm×0.50 mm.

The combined area of the example components just mentioned is equal to 69.9 square millimeters, which allows these components to fit comfortably within the cross-sectional area of the device 100 as illustrated in FIG. 1, which has an area of approximately 120 square millimeters (10 mm×12 mm). Furthermore, the maximum height of any of the example components just mentioned is equal to 1.00 mm. The thickness of the PC board 110 is 0.50 mm, for a total thickness of 1.50 mm. The maximum height available within the device 100 as illustrated in FIG. 1 is approximately 1.80 mm. The components mentioned above therefore may fit comfortably within the height of the device 100 as illustrated in FIG. 1. It should be appreciated that the particular components and dimensions thereof, and the overall dimensions, of the device 100 itself, need not be the same as the particular examples described herein.

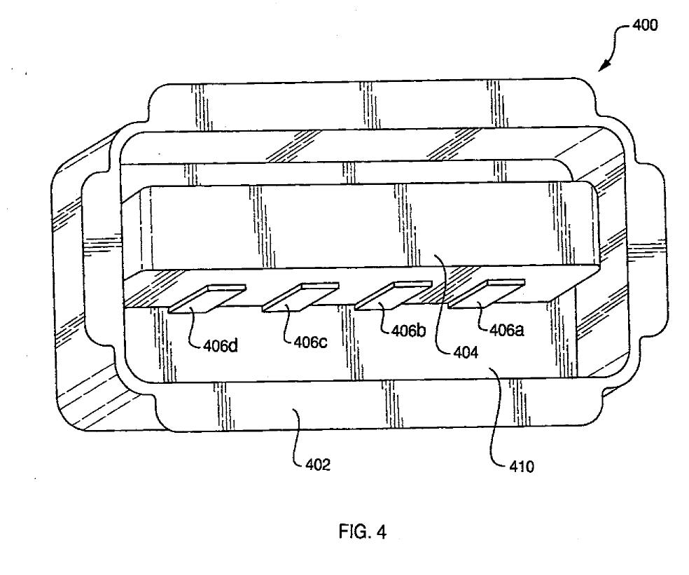

Referring to FIG. 4, a front perspective view is shown of a USB port 400. Although the port 400 is shown in isolation in FIG. 4 for ease of illustration, the port 400 may be coupled to any of a variety of devices, such as desktop or laptop computers, personal digital assistants (PDAs), printers, keyboards, mice, scanners, or digital cameras, to provide them with USB connectivity. The port 400 includes an external housing 402 forming a cavity 410 including a tongue 404. Gold-plated contacts 406a-d on lower surface 408 of tongue 404 are arranged to establish electrical connections with connector terminals 112a-d (FIG. 1), respectively, when the dongle 100 is mated with the port 400.

The dongle 100 (FIG. 1) may be mated with (i.e., coupled to) the port 400 (FIG. 4) by grasping the dongle 100 by the housing 102 and/or by the pigtail 106, aligning the housing 102 of the dongle 100 with the inner perimeter of the housing 402 of the port 400, and inserting the dongle 100 into the port 400. Referring to FIG. 5, a front perspective view is shown of the dongle 100 when partially inserted into the port 400. When the dongle 100 is fully inserted into the port 400, substantially all of the housing 102 (and electronics 104) are enveloped by the port 400. The pigtail 106, however, extends slightly from the port 400, thereby enabling the dongle 100 to be easily disengaged from the port 400 by grasping the pigtail 106 and pulling outward.

The pigtail 106, however, is optional. Alternatively, for example, a separate device (not shown) may be provided that may be engaged with the dongle 100 to remove the dongle 100 from the port 400. Elimination of the pigtail 106 may further reduce the volume of the dongle 100 and, in particular, may enable the entire dongle 100 to fit within the port 400. Such a dongle may advantageously be coupled to the port 400 without increasing the volume of the computing device containing the port 400.

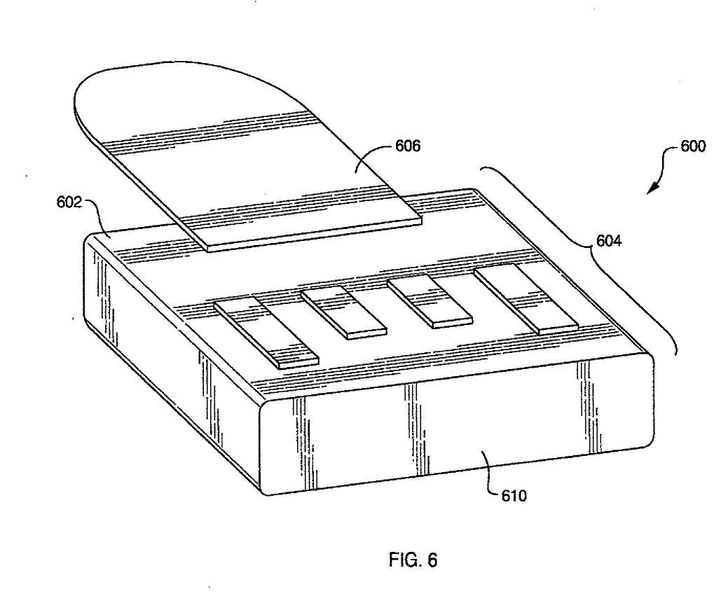

Referring to FIG. 6, a front perspective view is shown of a dongle 600 according to a second embodiment of the present invention. Unlike dongle 100, dongle 600 does not have an exterior housing. Rather, dongle 600 merely includes electronics 604 and a pigtail 606 coupled to upper surface 602 of electronics 604. Electronics 604 may have the same dimensions and otherwise have the same characteristics as the electronics 104 of the dongle 100 illustrated in FIG. 1. Pigtail 606 is optional, and may be replaced with alternative removal features, as described above.

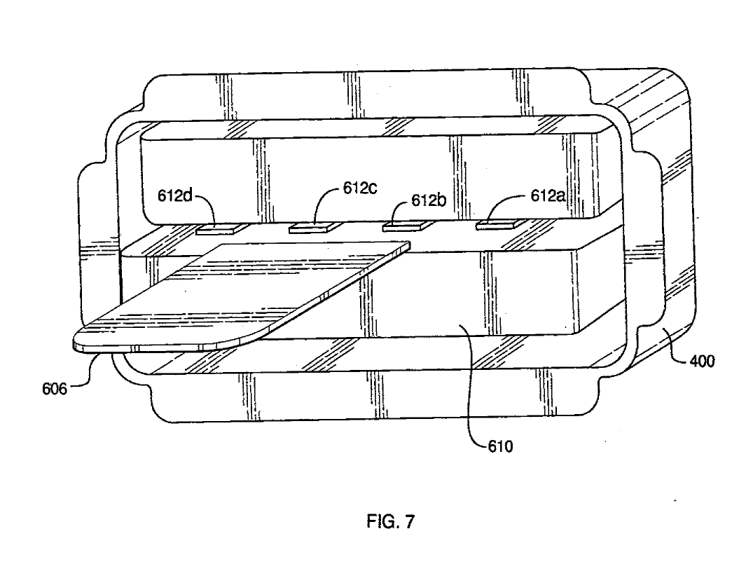

The dongle 600 may be mated with the port 400 (FIG. 4) by grasping the pigtail 606, aligning the PC board 610 of the dongle 600 with the inner perimeter of the housing 402 of the port 400, and inserting the dongle 600 into the port 400. Referring to FIG. 7, a front perspective view is shown of the dongle 600 when partially inserted into the port 400. When the dongle 600 is partially inserted into the port 400, the electronics 604 are completely enveloped by the port 400. The pigtail 606, however, extends slightly from the port 400, thereby enabling the dongle 600 to be easily disengaged from the port 400 by grasping the pigtail 606 and pulling outward.

Conventional device and connector housings typically perform the function of protecting the components they enclose from damage caused by exterior forces. Such a housing may be conveniently and advantageously omitted from the dongle 600 because the electronics 604 of the dongle 600 are fully enveloped by the housing of the port 400 when the dongle 600 is mated with the port 400, and are protected by encapsulant 210 when outside the port 400. The housing of the port 400 thereby performs the protective function that would normally be provided, at least in part, by a connector housing. Omitting the dongle housing reduces the overall size and weight of the dongle 600 and reduces the cost and complexity of manufacturing the dongle 600 in comparison to dongles having exterior housings.

Referring to FIG. 8, a schematic block diagram is shown of the electronics 104 of the dongle 100 according to one embodiment of the present invention. As shown in FIG. 8 capacitors 208b-c, voltage regulator 206, and USB processor 202 are connected in parallel. Ceramic resonator 214 is connected in series with USB processor 202. A common ground 802 is terminated at terminal 112a-Negative and positive data lines 802b-c are terminated at terminals 112b-c, respectively. A five-volt power supply line 802d is terminated at terminal 112d.

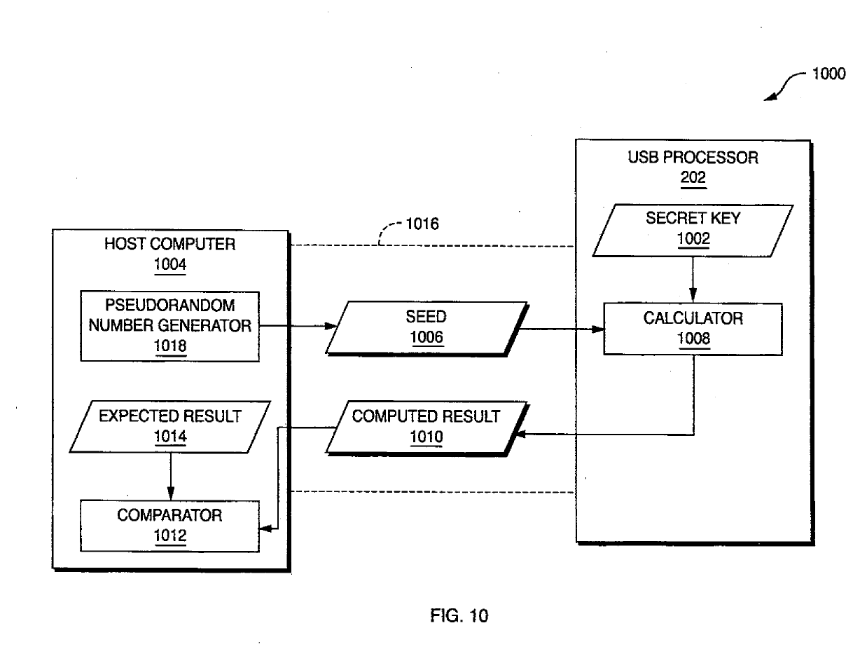

Data exchanged between a host computer and the USE processor 202 (as described below with respect to FIG. 10) is transmitted by means of differential digital signals on the data+ 802c and data− 802b wires. The +5V power 802d supplied by the host computer is stabilized by capacitor 208b and converted to the +3.3V power required by the USB processor 202 by means of the voltage regulator 208c, and which power is stabilized by capacitor 208c. The ceramic resonator 214 is used by the USB processor 202 to maintain a stable timebase for its internally clocked logic and its communication with the host computer.

Referring to FIG. 9, a flowchart is shown of a method 900 that may be performed by the USB processor 202 and a host computer 1004 (FIG. 10) to perform encryption key verification according to one embodiment of the present invention. Referring to FIG. 10, a dataflow diagram 1000 is shown which illustrates the operations performed by and the data flow between the USB processor 202 and the host computer 1004 according to the method 900 illustrated in FIG. 9.

The USB processor 202 may include firmware (not shown) for performing certain steps of the method 900. The USB processor may also be programmed with a unique, secret numerical key 1002 which cannot be read out from the processor 202. The host computer 1004 may include a USB port such as the port 400 (FIG. 4), and the method 900 may be performed when the dongle 100 is connected to the port 400 and a user attempts to access the host computer 1004 or a particular software program residing on the host computer 1004 or a remote host of which the host computer 1004 is serving as a client. Host computer 1004 and USB processor 202 may communicate over a USB connection 1016 that is established when the dongle 100 is connected to the port 400.

To authenticate the user of the dongle 100, the host computer 1004 uses a pseudo-random number generator 1018 to generate a pseudo-random seed 1006. The host computer 1004 transmits the seed 1006 to the USB processor 202 over the USB connection 1016 (step 902). The USB processor 202 uses a calculator 1008 to perform a calculation using the secret key 1002 and seed 1006 as inputs (step 904), thereby generating a computed result 1010. The USB processor 202 transmits the computed result 1010 to the host computer 1004 (step 906). The host computer 1004 uses a comparator 1012 to compare the computed result 1010 to an expected result 1014 based on the seed 1006 (step 908). The host computer 1004 provides access to the user if the comparator 1012 determines that the computed result 1010 is equal to the expected result 1014 (step 910). Otherwise, the host computer 1004 denies access to the user (step 912).

The operations performed by the calculator 1008 and comparator 1012 are described above in general terms because those of ordinary skill in the art will appreciate how to implement the calculator 1008 and the comparator 1012 using various conventional techniques to perform the functions described herein. Similarly, those of ordinary skill in the art will appreciate how to generate the expected result 1014 so that it can be used to verify that the computed result 1010 could only have been generated using a secret key (such as secret key 1002) stored in a legitimate dongle.

Among the advantages of various embodiments of the invention are one or more of the following. The dongles 100 and 600 shown and described above comply with the USB connector standard and are no larger than a USB connector. As a result, both of the dongles 100 and 600 may be entirely or substantially enveloped within the port 400 when coupled to the port 400. The dongles 100 and 600, therefore, do not extend appreciably from the port 400. One advantage of this feature is that the dongles 100 and 600 may be less susceptible to damage when coupled to the port 400 than conventional dongles. Furthermore, a computing device to which the dongles 100 and 600 are coupled may be easier to transport than a computing device having a conventional dongle coupled to it, because the computing device may be more easily kept in a user's pocket and/or stored and transported in a carrying case having an interior that matches the size of the computing device. In addition, coupling the dongles 100 and 600 to the port 400 may not affect the aesthetic appeal of the computing device containing the port 400 because the largely hidden dongles 100 and 600 may not appreciably affect the outward appearance of the device.

Another advantage of the dongles 100 and 600 is that their compact size may reduce the cost and complexity of manufacturing them in comparison to conventional dongles. In particular, the dongle 600 may be particularly easy and inexpensive to manufacture due to its lack of an exterior housing.

It is to be understood that although the invention has been described above in terms of particular embodiments, the foregoing embodiments are provided as illustrative only, and do not limit or define the scope of the invention. Various other embodiments, including but not limited to the following, are also within the scope of the claims.

Elements and components described herein may be further. divided into additional components or joined together to form fewer components for performing the, same functions. The particular electronics 104 illustrated in the drawings are provided merely as examples of electronic circuitry that may fit substantially within a USB connector and do not constitute a limitation of the present invention.

Furthermore, although the particular dongles 100 and 600 illustrated in FIGS. 1 and 6, respectively, perform the function of encryption keys, this is not a limitation of the present invention. Rather, devices implemented in accordance with the techniques disclosed herein may perform other functions, such as storing a security key for enforcing hardware or software access controls and/or copy controls. Furthermore, devices implemented in according with the techniques disclosed herein may perform the functions performed by persistent storage devices.

Although the dongles 100 and 600 described above are implemented to conform to the USB connector specification, this is not a limitation of the present invention. Rather, the techniques disclosed herein may be used to implement devices contained within other kinds of connectors, such as mini-USB connectors, IEEE-1394 connectors (also known as FireWire® connectors), and any other connectors which possess sufficient interior volume and supply usable power.

The techniques disclosed herein may be used to implement dongles for use with any kind of device, such as laptop computers, desktop computers, Personal Digital Assistants (PDAs), tablet computers, telephones, printers, monitors, and scanners.

The method 900 shown in FIG. 9 may be implemented, for example, in hardware, software, firmware, or any combination thereof. The method 900 may be implemented in one or more computer programs executing on a programmable processor, such as the USB processor 202 and a processor (not shown) within the host computer 1004. Each computer program within the scope of the claims below may be implemented in any programming language, such as assembly language, machine language, a high-level procedural programming language, or an object-oriented programming language. The programming language may, for example, be a compiled or interpreted programming language.

What is claimed is:

1. A device comprising:
a connector suitable for mating with a port; and
electronic circuitry, wherein substantially all of the electronic circuitry resides within the connector.

2. The device of claim 1, wherein all of the electronic circuitry resides within the connector.

3. The device of claim 1, wherein substantially all of the device resides within the connector.

4. The device of claim 3, wherein all of the device resides within the connector.

5. The device of claim 1, wherein the electronic circuitry comprises a microprocessor.

6. The device of claim 1, wherein the electronic circuitry comprises an electronic memory.

7. The device of claim 1, wherein the electronic circuitry comprises means for storing an encryption key.

8. The device of claim 7, wherein the electronic circuitry contains the encryption key.

9. The device of claim 1, wherein the electronic circuitry comprises means for storing a security key.

10. The device of claim 9, wherein the electronic circuitry contains the security key.

11. The device of claim 1, wherein the connector comprises:
a housing enclosing the electronic circuitry.

12. The device of claim 1, wherein the connector complies with a Universal Serial Bus standard.

13. The device of claim 12, wherein the connector complies with the Universal Serial Bus version 2.0 standard.

14. The device of claim 1, wherein the connector complies with IEEE standard 1394.

15. The device of claim 1, further comprising:
removal means for removing the device from the port.

16. The device of claim 15, wherein the removal means comprises a tab coupled to the connector.

17. A device comprising:
a connector suitable for mating with a port, the port having an inner surface defining a cavity; and
electronic circuitry having a volume that is no greater than the volume of the cavity.

18. The device of claim 18, wherein the volume of the connector is no greater than the volume of the cavity.

19. The device of claim 19, wherein the volume of the device is no greater than the volume of the cavity.

20. The device of claim 19, wherein the electronic circuitry comprises a microprocessor.
